(19) United States
(12) Patent Application Publication
(10) Pub. No.: US 2021/0304222 A1
(43) Pub. Date: Sep. 30, 2021

(54) FOOD TEMPERATURE MONITORING AND CERTIFICATON SYSTEM

(71) Applicant: SD Restaurant Solutions, Inc., Chula Vista, CA (US)

(72) Inventors: Rodrigo GRATIANNE, Chula Vista, CA (US); Victor Bernabe REYES, Chula Vista, CA (US); Carrie Elizabeth SMITH, Saratoga Springs, NY (US)

(21) Appl. No.: 17/132,524

(22) Filed: Dec. 23, 2020

Related U.S. Application Data
(60) Provisional application No. 63/001,995, filed on Mar. 30, 2020.

(51) Int. Cl. G06Q 30/00; G06F 3/12; G08B 5/36; G08B 3/10; H04Q 9/00; G06Q 10/08; G06Q 50/12; G06K 1/12; G01K 1/024; G01K 13/00

(52) U.S. Cl. CPC G06Q 30/0185; G06F 3/1286; G08B 5/36; G08B 3/10; H04Q 9/00; G06Q 50/26; G06Q 50/12; G06K 1/121; G01K 1/024; G01K 13/00; H04Q 2209/40; G06Q 10/087

(57) ABSTRACT

A food temperature monitoring and certification system includes a temperature probe, a remote communication device, and in further implementations, a base communication device, a cloud database and a printer. The temperature probe will be in wireless communication with the remote communication device or base communication device. The temperature of the food item is taken by the probe and monitored by the remote communication or base communication device when the same enters a “danger zone” defined by the temperature of the food item. Temperature data is continuously transmitted to the remote communication device or base communication device. The base communication device is configured to sense the physical presence or proximity of the temperature probe (using proximity type wireless communication protocols) and in response prints unique scannable codes that provide access to the temperature data relating to that particular pan of food, thus providing a receiver of the food with certification as to the food handing prior to their receiving the same.

### BACKGROUND

### Technical Field

The present invention relates to food thermometers. More particularly, it relates to a food thermometer and associated system that monitors the temperature of food from the time of preparation to a time when that food or leftovers thereof are reduced to temperatures below 41° F. in order to certify safety of the food handling for a subsequent receiver of the food (e.g., a charitable food service) and to provide internal staff with operations data.

### Description of Related Art

In the food service industry, food service professionals are asked to monitor the internal temperature of prepared foods in an effort to prevent a biologically contaminated food item from being served. Potentially hazardous food has a predetermined time of holding in the temperature “Danger Zone” before it is considered unsafe for consumption. Current practices include monitoring the internal temperature of a food item with a thermometer and logging the read temperatures on or in a temperature log. This method has many disadvantages, not the least of which includes the possibility of mismanaged or inaccurately entered time for temperature readings, thus thwarting the integrity of the logged data.

In addition to the “serving” of food, the often unused food in these food industries gets wasted (thrown away) or donated to food service charities and organizations, which in turn serve the same to those individuals in need. Unfortunately, the reliability of the food storage information prior to this donation is problematic and can result in the transfer of food that may be biologically contaminated, although all efforts to prevent the same may have been attempted.

The present invention addresses and solves this problem by providing a food temperature monitoring system that not only can make sure that the food does not fall within the “Danger Zone” temperature for a period of time that is beyond acceptable limits, according to the Food and Drug Administration (FDA), but also operates to certify such food storage to the food banks or organizations receiving the same.

In addition to the above, the present invention operates to ensure that the food being served on site (e.g., in a hospitality environment or otherwise) is safe by providing the kitchen staff with real time data of the food temperature at all times from preparation to serving/storing.

### SUMMARY OF THE INVENTION

This and other aspects of the invention are achieved with a food temperature monitoring and certification system having at least one temperature probe and a remote communication device in wireless communication with the at least one temperature probe. The temperature probes have a power source and a processor and are configured to transmit data relating to food temperature. The remote communication device is configured to record temperature readings from the temperature probe(s) and to maintain one or more timers associated with the temperature readings of each temperature probe(s).

In accordance with another implementation, the food temperature monitoring and certification system includes at least one temperature probe, a base communication device and a printer. The temperature probe(s) has/have a power source and a processor and is configured to transmit data relating to food temperature. The base communication device includes a processor and memory and is configured to wirelessly sense the presence of the temperature probe(s) when the temperature probe(s) is/are removed from a charging source. The base communication device automatically receives temperature data from the temperature probe(s) upon sensing of the same. The printer is communication with the base communication device is configured to print unique scannable codes corresponding to temperature data retrieved from the temperature probe(s) by base communication device.

In accordance with further implementations, a cloud database/server is in communication with the remote communication device, such that the remote communication device is further configured to upload the received information from the temperature probe(s) to the cloud database upon connection of the temperature probe to the remote communication device.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1A is a plan view of the food temperature monitoring and certification system according to one embodiment of the invention;

FIG. 1B is a plan view of the food temperature monitoring and certification system according to another embodiment of the invention;

FIG. 1C is a plan view of the food temperature monitoring and certification system according to yet another embodiment of the invention;

FIG. 1D is a plan view of the food temperature monitoring and certification system according to another further embodiment of the invention;

FIGS. 2A, 2B, 2C, 2D and 2E are top, front, right side, left side and bottom elevational views respectively of the food temperature probe according to an embodiment of the invention;

FIG. 3A is a plan view of a food pan with the food temperature probe according to an embodiment of the invention;

FIG. 3B is a plan view of the transfer of food from the food pan with the temperature probe to a disposable food pan according to an embodiment of the invention;

FIG. 3C is a plan view of the temperature probe and base communication device used to certify the food temperature monitoring, according to an embodiment of the invention;

FIG. 3D is a plan view of a disposable pan containing food certified by the system and including a scan code to support such certification, according to an embodiment of the invention;

FIGS. 4 and 5 are a flowchart representing the method for food temperature monitoring and certification according to an embodiment of the invention;

FIG. 6A is a block diagram of the food temperature monitoring and certification system according to one embodiment of the invention; and

FIG. 6B is a block diagram of the food temperature monitoring and certification system according to another embodiment of the invention.

### DETAILED DESCRIPTION

In the following description, certain specific details are set forth in order to provide a thorough understanding of various disclosed implementations. One skilled in the relevant art will recognize that implementations may be practiced without one or more of these specific details. In other instances, well-known structures and devices associated with food temperature devices and related apparatuses, systems, and methods may not be shown or described in detail to avoid unnecessarily obscuring descriptions of the implementations.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one implementation” or “an implementation” or “one embodiment” or “an embodiment” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The intended purpose/function of the present invention is to prevent biologically contaminated food from being consumed. This is done by monitoring the internal food temperature with the present system, and making sure that the food does not fall within a “Danger Zone” of temperature for a period of time that is beyond acceptable limits, according to the Food and Drug Administration (FDA). In accordance with industry standards, FATTOM is an acronym that stands for Food, Acid, Temperature, Time, Oxygen and Moisture (microbe growing conditions) which specifies favorable conditions for the growth of foodborne pathogens. According to current standards, the general rule is a 2 hour window from 135 F-70 F and a four hour window from 70-41 F. In other words, prepared foods need to adhere to certain cooling criteria to ensure it is safe for human consumption. According to current standards, food must be lowered from an internal temperature of 135 F to 70 F in two (2) hours or less AND must be lowered from an internal temperature of 70 F to 41 F in four (4) hours or less, if the food should fail to meet both these criteria, the potential for biological contaminants to form is significantly increased.

It is to be understood that the present application relates to the “Danger Zone” as set by the industry standards as it relates to these temperatures and timing. Thus, the present invention and principles described herein are equally applicable to any temperature or time changes in this danger zone as set by the industry. Any subsequent consumption of this food could cause sickness for those individuals ingesting the same, especially if those individuals are immunocompromised and at a higher risk of foodborne illness. The present invention eliminates this concern by not only monitoring the internal temperature of the food items, but by maintaining a real time database of the same which is used to create scannable codes that operate to “certify” to a receiving party that the food in the pan was properly stored and managed prior to delivery to reduce the formation of biological contaminants.

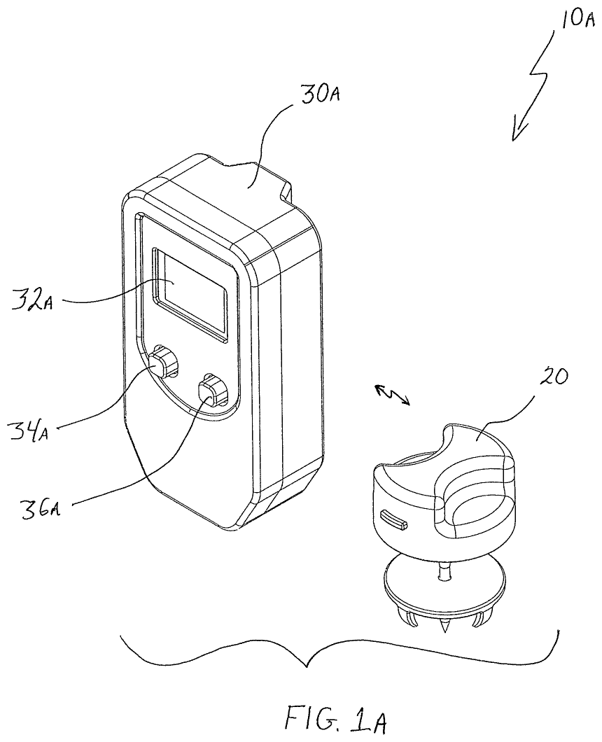

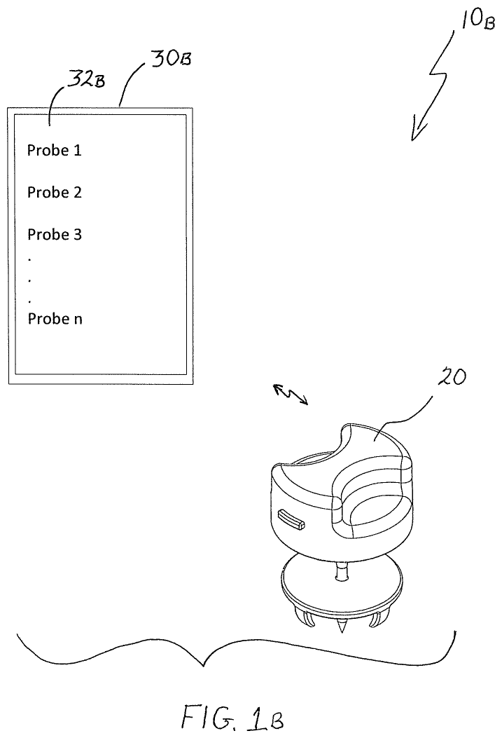

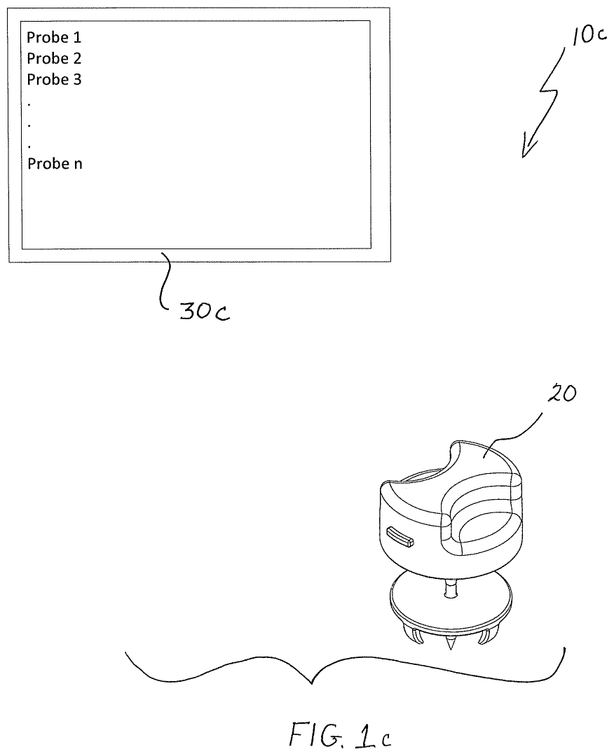

FIG. 1A shows an example of the food temperature monitoring and certification system 10 according to one embodiment of the invention. In this implementation, a food temperature probe 20 is in constant wireless communication with a remote communication device 30A once the probe is removed from its charging source (not shown). The remote communication device includes a display 32A of any suitable type (e.g., LCD or LED) and one or more manual controls 34A, 36A. In this example, the remote communication device 30A is designed specifically for the probe 20, but in other implementations (discussed below), the remote communication device can be a portable screen (e.g., smart phone), a tablet, or other portable computing device capable of communicating with a plurality of temperature probes. In this embodiment, kitchen staff will be able to transport and check the remote communication device to monitor the temperature of the food within which the temperature probe 20 is positioned.

As will be described in more detail below, the remote communication device 30A either has an integrated interface or display that displays information of multiple temperature probes 20 (e.g., up to 12 or even more) in real time near the service area. In addition, as will be described in more detail below, the remote communication device 30A is responsible for maintaining all timers associated with each of the probes it is in communication with.

FIG. 1B shows another embodiment 10B of the temperature monitoring and certification system. In this implementation, the remote communication device 30B is a portable device that includes a display screen 32B and is configured to provide the user with a visual display of one or more probes 20 and their current temperature reading and time. Here, the remote communication device 308 could be a small tablet, a smart phone or other smart device configured to wirelessly communicate and connect with the probes 20 and maintain a timer for each probe connected to the same.

In an implementation where remote communication device 30B is a smartphone, the probes 20 can communicate temperature information to a local database which would transmit that data to a cloud server. The smartphone 30B would have an app running on the same that allows the user to access the cloud server and keep a real time monitor on the probes and associated food items.

FIG. 1C shows another embodiment 10C of the temperature monitoring and certification system. In this implementation, the remote communication device 30C is a remote screen positioned, for example, in the kitchen on a wall where it is completely visible to the entire kitchen staff. In this implementation, the remote communication device 30C that is wirelessly connected to the probes has a display 32C that provides a visual list of the connected probes and displays each of the timers associated with each of the probes it is in communication with.

In accordance with a preferred implementation, the remote communication device 30 is configured to send/receive data from the cloud and receive temperature information from the probes, while maintaining timers for each probe, and alarms or triggers according to the method of the present invention.

FIG. 1D shows yet another embodiment 10D of the temperature monitoring and certification system. In this implementation, a base communication device 40 is in direct communication with the temperature probes 20. In this implementation, the kitchen staff can still have a remote communication device 30B providing them with updates on temperature and timing for the probes, however, this is not as necessary and could be eliminated by the implementation of the base communication device 40. The base communication device 40 is a preferably computing device having either an integrated or connected display screen 42, and preferably includes a printer 44 that is connected to the same either via wired or wireless connection.

The temperature probes 20 of the invention are configured to take temperature readings and transmit that data to the remote communication devices 30 and/or the base communication device 40 using wireless technology, such as RFID or LoRa, or any other wireless communication protocol. In some embodiments, the probes 20 can include visual indicators such as lights or LEDs, and may or may not include an audible indicator.

In accordance with one implementation, the base communication device 40 is configured to receive temperature data from the probes or the remote communication devices 30, maintain timers for each probe when there are no remote communication devices, or when the same are not configured to keep time, communication with the probes via RFID, LoRa or any other wireless protocol, receive inputs relating to the food items, and communicate with a printer to print OR codes (discussed in more detail below).

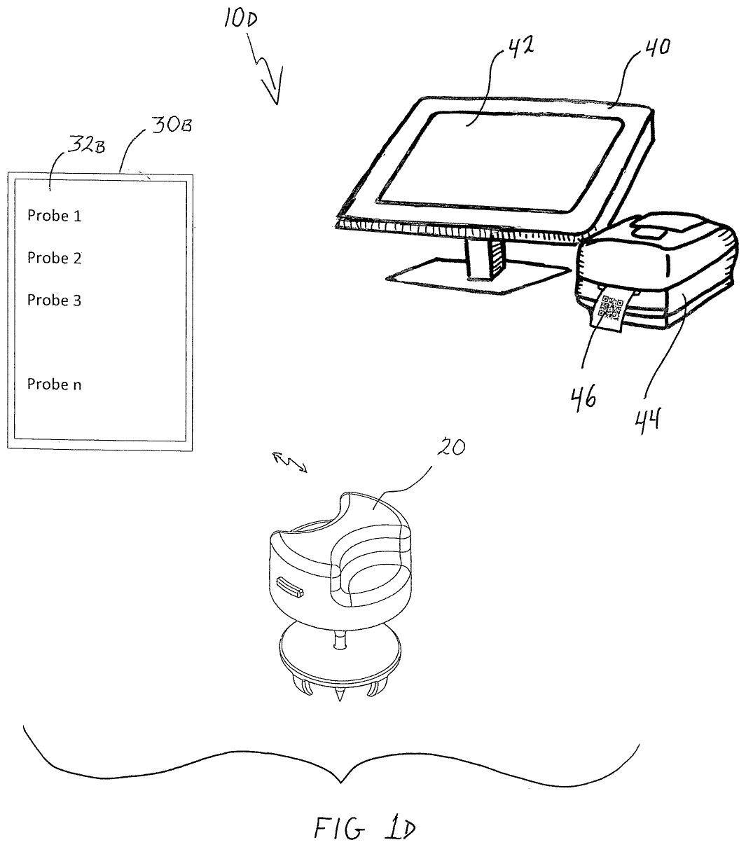

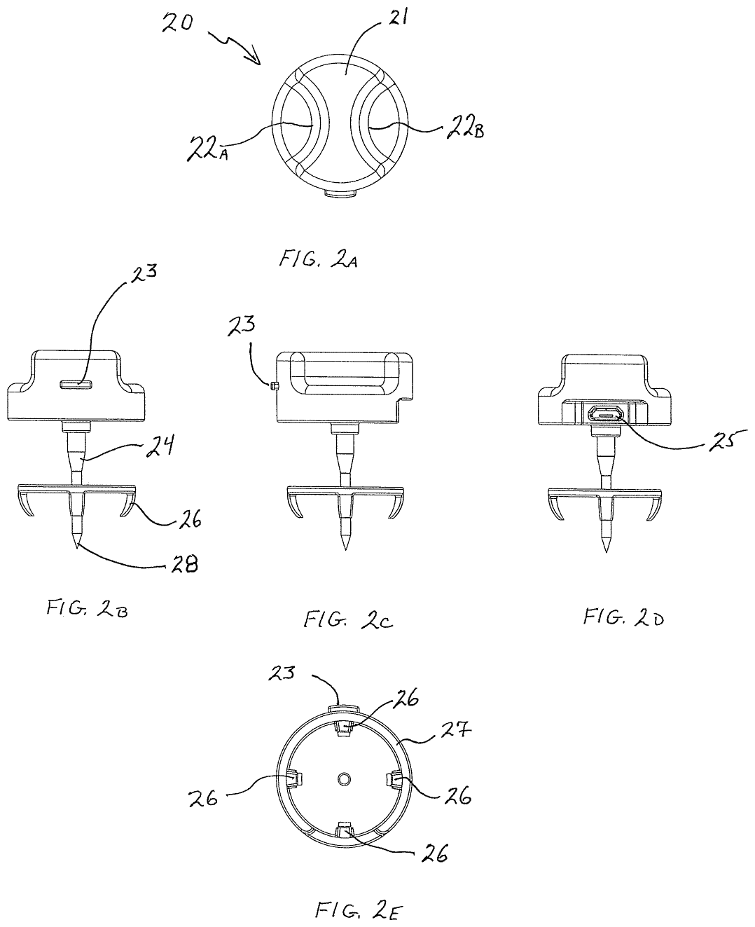

FIGS. 2A-2E show elevational views of an exemplary temperature probe 20, according to an implementation of the invention. The probe 20 includes a body 21 having cutouts or indentations 22A, 22B on opposing sides thereof to ease in the user's handling of the same. In one embodiment, a power button 23 can be positioned anywhere on the body 21 and is shown on a side thereof in FIG. 2B for example. In another embodiment, the probe 20 will automatically/wirelessly pair with the remote communication device 30 when removed from a charging base or from a charging source of any kind. A charging interface connection 25 can also be positioned anywhere on the body 21 and is shown in this example on a side thereof in FIG. 2D. The charging interface 25 can be a USB connection or any other suitable type of connection interface for purposes of charging an internal battery. In alternative embodiments, the internal battery may be removable and/or not rechargeable. As shown in FIGS. 2B-2E, the probe includes a probe shaft 24 that terminates in a point 28 for penetrating the food item. An additional annular ring 27 of insertion points 26 can also be included and which operates as a stop and provides stability to secure the temperature probe into the food item and thus keep the probe tip 28 from any movement once so positioned. Although probe 20 is shown in a particular configuration in this exemplary embodiment, it is to be understood and appreciated that the body 21 can take on any desired shape, and the configuration of the probe shaft 24, annular ring 27, insertion points 26 and/or probe tip 28 can also vary without departing from the intended spirit and scope of the present invention disclosure.

In accordance with one embodiment, the operation of the invention as shown in FIGS. 1A-1C is described. In this implementation, the user removes the probe 20 from its charging source, and it can either be manually powered up, or automatically powered up by removal from the charging source. Once powered up, the probe 20 wirelessly connects to the remote communication device 30. Once inserted into the food, the probe immediately takes and monitors the temperature of the food item. At the same time, the probe 20 communicates those temperature readings to the remote communication device 30. The remote communication device maintains a timer for each probe 20. The carrier or user of the remote communication device 30 now can monitor the temperature of food items remotely and keep track of the temperatures and time to manage the appropriate food handling for subsequent storage. In this manner, the data relating to each food item and the temperatures and timing of the same are maintained in the same chain of custody. The data stored by the remote communication device is accessible to the executive chef or kitchen administrator to review at any given point.

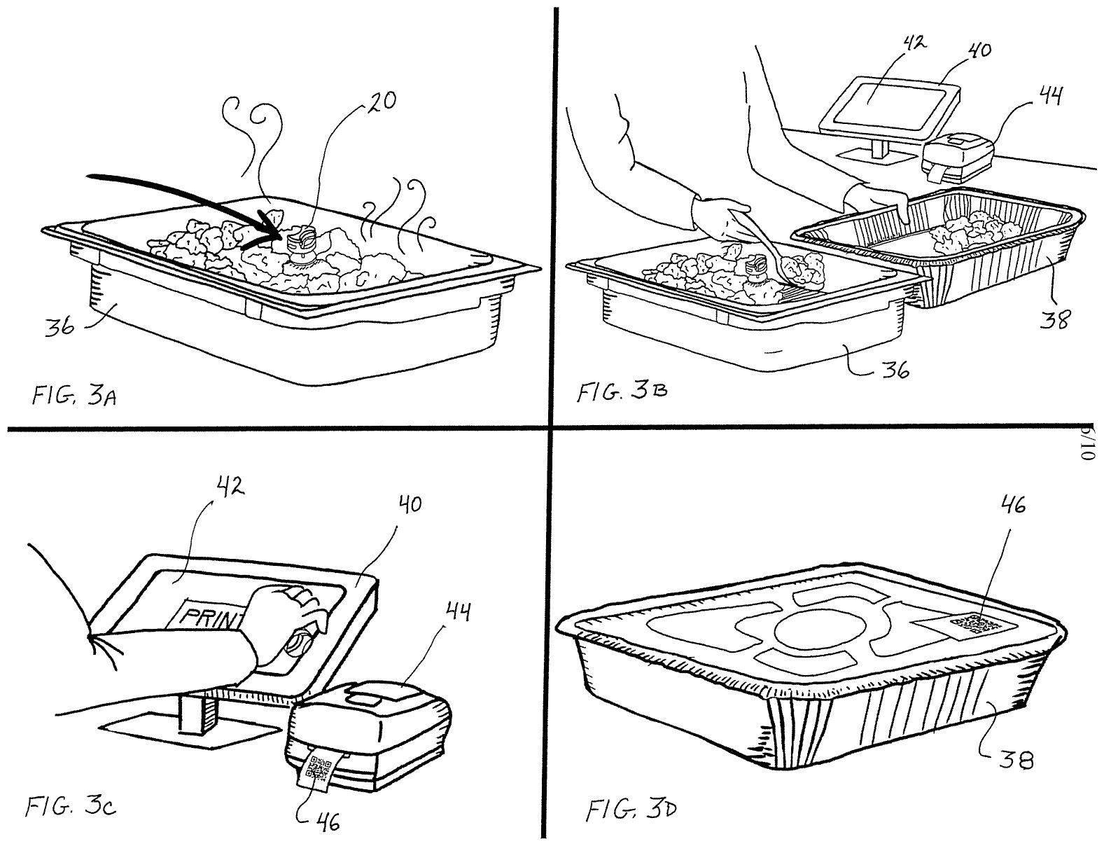

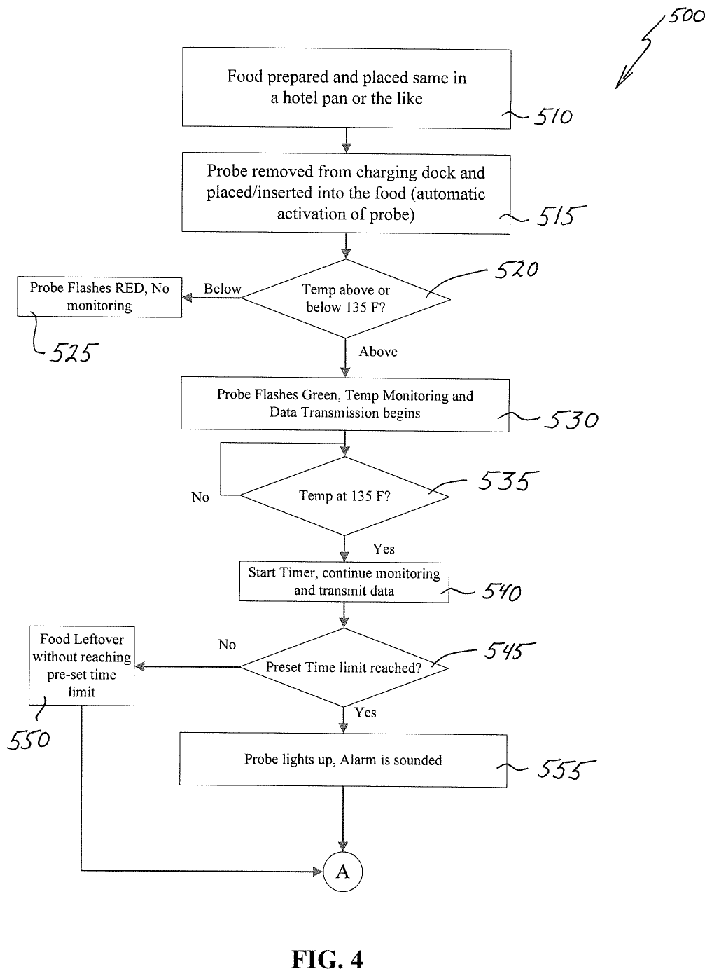

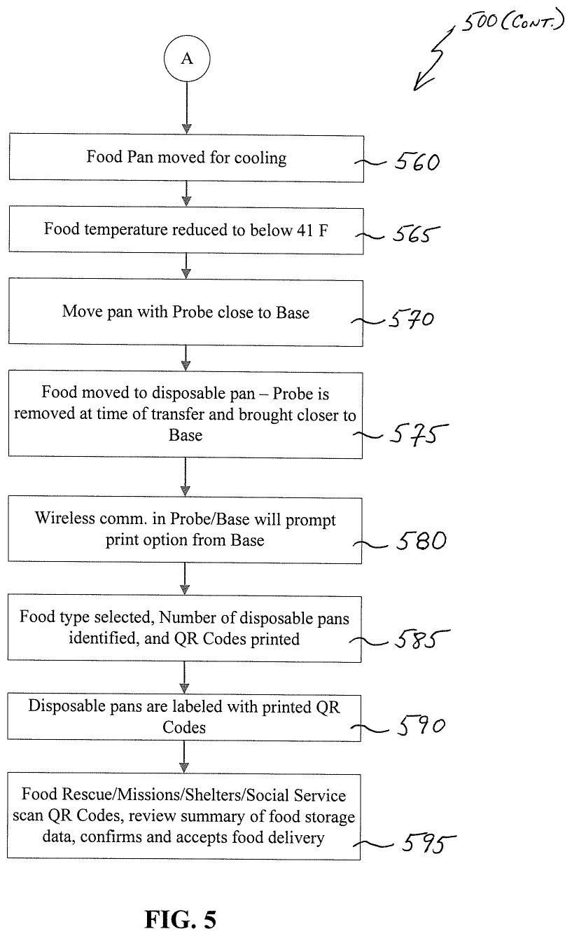

In accordance with the further embodiment shown in FIG. 1D, the operation of the invention will now be described in reference to FIGS. 3-5. FIGS. 3A-3D visually shows some of the steps (and the hardware) that will be described in the method 500 disclosed in FIGS. 4-5. Initially, food is prepared and placed in a hotel pan 36 or the like (510) and the temperature probe 20 is removed from its charging source and then placed/inserted into the food (515) (See FIG. 3A). In most cases, food is prepared and panned in the kitchen, then placed in a heat warmer referred to as a “Hot Box” which is wheeled to the serving area to hold and replenish quantities as needed. The remote communication device 30 is positioned outside the Hot Box and will display information of the probes on the display screen 42. In the embodiment where the base communication device 40 is not a tablet or other computing device with a sufficiently sized display, the remote communication devices 30A-30B, or remote screen 30C will be in communication with the base communication device 40 that is also coupled to a printer 44 and which would provide the probe information to the kitchen staff.

Prior to the insertion of the temperature probe into the food, it is confirmed that the same is completely charged (e.g, it is removed from a charging dock or source). In accordance with one embodiment, the activation of the probe 20 is automatic (i.e., upon insertion into the food item, or removal from the charging source). In another embodiment, the activation of the probe 20 can be manually done by pressing the button 23 provided on the body 21 to “start” temperature monitoring. As noted above, the probe or probes 20, upon activation, will automatically connect/communicate with the remote communication device 30, which in turn will immediately start monitoring temperature data and timers for each probe.

Once activated, the probe 20 is in wireless communication with the remote communication device 30 and immediately takes the temperature of the food item and determines (520) if the temperature is above or below 135° F. If below 135° F., the probe flashes a light (e.g., a red colored light) on the probe, and no monitoring is performed, as this food item has been identified as being below the 135° F. threshold and thus, we cannot certify or confirm for how long. That food item is understood to be a “no go” item and cannot be certified for donation purposes.

If upon insertion of the temperature probe, it is determined (520) that the temperature is above 135° F., the probe flashes another light (e.g., a green colored light) either on the probe and/or at remote communication device 30, and the remote communication device 30 immediately starts monitoring the internal temperature of the food item which can be transmitted to a cloud server database (530). In one embodiment, the remote communication device 30 will monitor all time periods and correlate the same with the temperature data received from the respective probes. In another embodiment, the temperature probe could include more processing capability and thus could be able to monitor both temperature and time and transmit that data to the remote communication device 30 on demand or contemporaneously with recording the same.

The probe 20 then continuously take (535) the temperature of the food item and the remote communication device 30 determines when the same reaches the 135° F. threshold. If not (i.e., the food temp is still above the 135° F. threshold), the probe continues to check temperature (535). When the temperature reaches the 135° F. threshold, the remote communication device 30 starts a timer and the temperature monitoring and storing of data continues (540). Next, it is determined (545) whether a predetermined time limit has been reached. As discussed above, when the temperature of the food item reaches (i.e., is cooling down to) 135° F., it is entering the “danger zone” and as discussed above, the time within which the food item can be in this zone is currently limited to 2 hrs (120 minutes).

When the food is leftover and the timer maintained at the remote communication device 30 does not reach the preset time limit (550), the food pan is moved for cooling (560)—In other words, in this instance (550), the food pan is moved for cooling (560) before the preset time limit (of 120 minutes) has run. In the event that it is determined (545) that the preset time period has been reached or more preferably is imminently going to be reached, the probe lights up (in any color) and can sound an audible alarm (and/or a visual alarm) at the remote communication device 30 notifying the surrounding users that this food is on its way (i.e., cooling down quickly) to reaching the time limit in the danger zone and must now be moved for cooling (560). In a preferred embodiment, the preset time period (545) for the system is less than the 2 hour (120 minute) standard set by the FDA, in order to provide time to the kitchen personnel to respond to the audible and/or visual notification provided by the system and handle the movement of the food to the cooling process. For example, the preset time period can be 105 minutes (15 minutes before the expiration of the preset time period), 90 minutes (30 minutes before the expiration of the present time period), etc.

The cooling process involves reducing the food item temperature to below 41° F. (565). Once so cooled, the pan 36 with the temperature probe 20 is moved closer to the base communication device 40 (570) as shown in FIG. 3B. Here, the food is moved to a disposable pan 38 (575). \Mien the food is moved to the disposable pan, the temperature probe 20 is removed and brought into closer proximity to the base communication device 40 (See FIG. 3C), In this example, the base communication device 40 is a tablet or any other suitable type of computing device.

The base communication device 40 which is already in wireless communication with the temperature probe 20, senses the proximity of the temperature probe 20 and in response prompts the user for a printing option via display 42. Using the base communication device/tablet 40, the operator would select the food type, the number of disposable pans or scannable codes (e.g., OR codes) to be printed (585). The printer 44 then outputs labels with scan codes 46 thereon (FIG. 3C). The disposable pans 38 are then labeled (590) with the scan codes 46 (FIG. 3D).

Once labeled, the receiver of the food, for example a food rescue mission, shelters or social services can scan the OR codes, review the summary of the food storage data and can thereby safely confirm and accept the food delivery. As will be apparent from the above description, maintaining the stored records of the food handling that the receiver of the food can review upon receive of the same, can increase confidence and operates to “certify” to that receiver that the food they are receiving was properly and safely handled (stored) prior to their receiving of the same.

In accordance with one implementation, all active temperature probes 20 are in communication with a base communication device 40. An application running on the base communication device will provide the user interface via the corresponding display 32B and enable the food selection, probe selection, printing options, etc. Alternatively, in another implementation this function could be performed by the remote communication device 30.

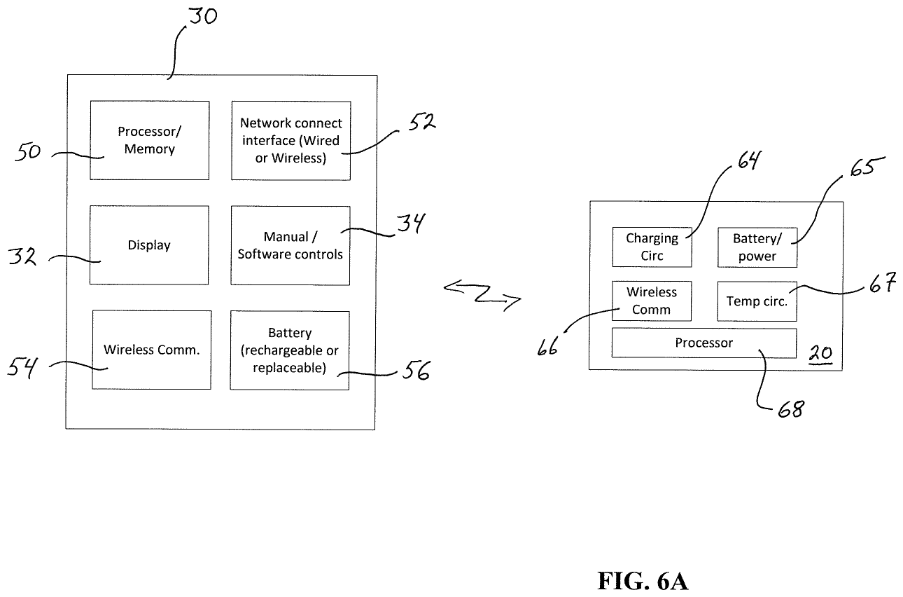

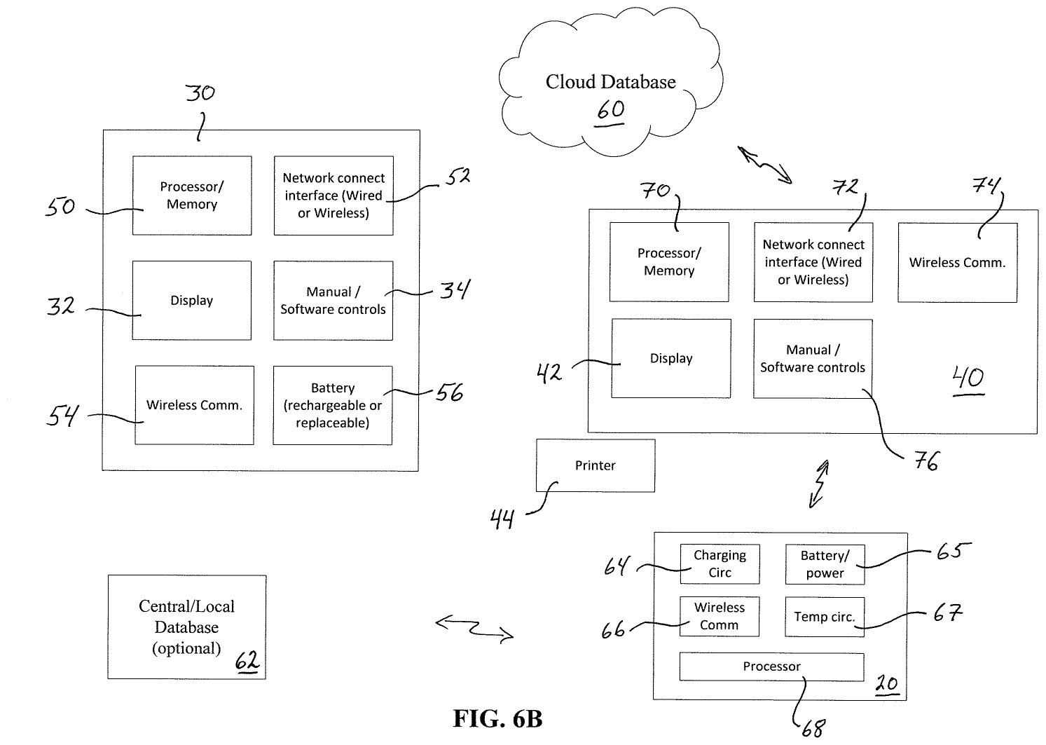

FIG. 6A shows a block diagram of the food temperature and monitoring system 600 according to one implementation of the present principles. The system includes a remote communication device 30, and one or more temperature probes 20. In this embodiment, as described above, the remote communication device 30 maintains timers for each probe 20 and provides the carrier/user with real time updates as to the food item temperature for each probe. In this manner, the carrier/user of the remote communication device 30 and the data contained therein will allow for confirmation of the chain of custody of the respective food item.

In accordance with one implementation, the remote communication device 30 includes a processor/memory 50, a display 32 of any suitable type, and some manual or software controls 34. A battery 56 can be replaceable or rechargeable. A network interface 52 is provided and it can be a wired or wireless protocol interface that allows the remote communication device 30 to communicate with the probes 20 and optionally a central or local database 62.

Further, a wireless communication circuit or module 54 is included in the remote communication device 30. This wireless communication circuit 54 or module is configured to enable the remote communication device 30 to communicate with the one or more temperature probes 20 which include similar circuitry/module 66.

In accordance with another embodiment shown in FIG. 6B, the base communication device 40 includes a processor/memory 70, a network interface 72, wireless communication circuitry 74, and manual or software controls 76. The base communication device is in communication with the one or more probes 20, the printer 44, and depending on implementation may or may not include remote communication devices 30, and a central database 62. In the preferred embodiment, the base communication device 40 is in communication with a cloud database 60 and no central database is required.

In accordance with one implementation, the temperature probe 20 includes a battery power source 65, a charging circuit 64, the temperature circuitry 67, and a wireless communication circuit/module 66. A processor 68 may also be included to enable the probe 20 to handle all processing necessary for temperature reading, support of all wireless communication protocols/circuitry as needed, and could even include a memory for purposes of running applications that may, in future embodiments allows the probe to be programmed with specific desired operating characteristics.

In one implementation, the wireless communication circuits/modules 54, 66 and/or 74 can be based in Radio frequency technology such as LoRa (Long Range), or any other wireless communication protocol that enables the continuous communication between probes and the base communication devices. In other contemplated embodiments, wireless communication circuits/modules 54, 66 and 74 can also include RFD technology so that when the temperature probe 20 is brought into proximity to the base communication device 40, the base communication device 40 automatically senses the RFD tag of the probe and immediately prompts the user with the print option for the scan codes with corresponding temperature data.

In another implementation, near field communication (NFC) tags can be used in the probe and corresponding software in the base communication device which also enable an automatic sensing of a temperature probe once the same is brought into proximity to the base communication device 40 for purposes of prompting the print option. Other communication protocols can be implemented for wireless communication circuits/modules 54, 66 and 74 without departing from the intended scope of the invention. For example, other wireless protocols such as, for example, Bluetooth and even line of sight type of wireless protocols (e.g., infrared) could be implemented herein depending on the kitchen/working environment.

Once a temperature probe 20 is in communication with the base communication device 40 (e.g., upon removal of the temperature probe from a charging source), the base communication device 40 immediately starts reading the temperature probe 20 data and stores the same into the cloud database 60 and depending on the application and installation, may also simultaneously store the data in a central or locally located database 62. This data is processed, and the user is provided, through the application running on the base communication device 40, options to print 44 a scannable code 46 relating to that data. Those of skill in the art will appreciate that the scannable code 46 can be any type of scannable barcode, OR code, or the like.

As mentioned above, when the receiver of the food scans the scannable code 46, their system can be configured to either: 1) download the stored data relating to the temperature probe and particular food pan so they can review the same; 2) access the cloud database 60 where the data is stored so they can review the same; and or both of the above. In this manner, the receiver of the food can be assured to have full access to the food storage records relating to a particular pan of food being delivered and thus can certify the safety of the same before accepting the food.

In accordance with a further embodiment, and referring to FIG. 6B, the remote communication device 30 can be a smartphone and the temperature probes 20 are configured to wirelessly transmit temperature information to a local database 62, which is then configured to transmit that received temperature data to the cloud server/database 60. The smartphone remote communication device 30 will have application software running on the same, and which is configured to allow the user to see/review all temperature/timing information at the cloud server/database 60 substantially in real time. In this implementation; the temperature probes 20 would communicate with the local database/server 62 using wireless technology, such as, for example, LoRa. The local database/server 62 would then transmit the received temperature data to the cloud server/database 60 using WiFi or any other wireless protocols. In this manner, the user of the smartphone remote communication device would have access to all the temperature probe data and would receive alarms or indicators at the same.

Aspects of the present principles are described with reference to flowchart illustrations and/or block diagrams of methods; apparatus (systems) and computer program products according to embodiments of the same. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus/device to produce a machine, such that the instructions, which when executed by the processor of the general purpose computer, special purpose computer, or other programmable data processing apparatus/device, creates a means for implementing the functions/acts specified in the flowchart and/or block diagram block or blocks.

The computer program instructions may also be stored in a computer readable medium, for example, as described above, that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. A food temperature monitoring and certification system comprising:
at least one temperature probe having a power source and a processor, the temperature probe being configured to transmit data relating to food temperature;
a remote communication device in wireless communication with at least one temperature probe and being configured to record temperature readings from at least one probe, and to maintain one or more timers associated with the temperature readings.

2. The food temperature monitoring and certification system of claim 1, wherein the wireless communication between the remote communication device and at least one temperature probe comprises radio frequency (RF) or any other wireless communication protocol.

3. The food temperature monitoring and certification system of claim 1, wherein the power source of the temperature probe is rechargeable, and at least one temperature probe further comprises a charging port/interface to enable the connection of an external charging power source to the rechargeable power source.

4. The food temperature monitoring and certification system of claim 1, wherein the at least one temperature probe is configured to continuously transmit temperature data for a predetermined period of time when:
the food item is above the threshold temperature at the time of initial insertion of the probe into the food item; and
the food items then reaches the threshold temperature after having been initially identified as being higher than the threshold temperature.

5. The food and temperature monitoring and certification system of claim 4, wherein the threshold temperature is 135° F. and the predetermined time is no more than two hours.

6. The food temperature monitoring and certification system of claim 1, wherein the at least one temperature probe comprises a shaft, a tip and a stop ring, the stop ring being configured to limit a distance of insertion into the tip and shaft into the food item, and providing additional stability to the temperature probe.

7. The food temperature monitoring and certification system of claim 6, wherein the stop ring is an annular ring having the shaft at a center thereof.

8. The food temperature monitoring and certification system of claim 1, further comprising a cloud database in communication with the remote communication device, the remote communication device being further configured to upload the received information from the temperature probe to the cloud database upon connection of the temperature probe to the remote communication device.

9. A food temperature monitoring and certification system comprising:
at least one temperature probe having a power source and a processor, the temperature probe being configured to transmit data relating to food temperature; and
a base communication device having a processor and memory and being configured to wirelessly sense the presence of at least one temperature probe when at least one temperature probe is removed from a charging source, the base communication device automatically receiving temperature data from at least one temperature probe upon sensing of the same; and
a printer in communication with the base communication device and being configured to print unique scannable codes corresponding to temperature data retrieved from at least one temperature probe by the base communication device.

10. The food temperature monitoring and certification system of claim 9, further comprising a cloud database in communication with the base communication device, the base communication device being further configured to upload the received information from the at least one temperature probe to the cloud database upon connection of the at least one temperature probe to the base communication device and correlate that data to the unique scannable code printed for the food item.

11. The food temperature monitoring and certification system of claim 10, wherein the scannable code printed for the food item provides a receiver of the food with access to the cloud database so they can view the temperature and time data relating to the food item.

12. A method of monitoring and certifying the handling of food items according to the apparatus of claim 9, the method comprising:
inserting the temperature probe into a food item;
determining if the temperature of the food item is above a threshold temperature;
begin monitoring and transmitting temperature data when the temperature of the food item is determined to be above the threshold temperature;
starting a timer at the base communication device when the temperature of the food item reaches the threshold temperature, the timer being set for a predetermined period of time;
notifying a user when the predetermined period of time is imminently about to expire;
moving the food item with the temperature probe closer to a base communication device when either the predetermined period of time has not yet expired, or when it is imminently going to expire and the user is notified;
transferring the food item to a disposable pan; and
printing unique scannable codes from the printer corresponding to the stored data relating to the food item handling and placing the printed unique scannable codes on the disposable pan with the corresponding food item.

13. The method of claim 12, further comprising identifying the food item as a “no go” item when it is initially determined that the food temperature is under the threshold temperature upon insertion of the probe into the food item.

14. The method of claim 12, wherein said notifying comprises illuminating a light and/or sounding an audible alarm on the remote communication device.

15. The method of claim 12, wherein the threshold temperature is 135° F. and the predetermined period of time is less than two hours.

16. The method of claim 12, where the printing of unique scannable codes further comprises:
moving the temperature probe into proximity to the base communication device;
sensing by the base communication device the temperature probe; and
printing the unique scannable codes corresponding to the data transmitted to the base communication device by the temperature probe and time data maintained by the base communication device for this temperature probe.
